(19) United States
(12) Patent Application Publication
(10) Pub. No.: US 2026/0320799 A1
(43) Pub. Date: Oct. 15, 2026

(54) IMAGE PROCESSING APPARATUS, IMAGE PROCESSING SYSTEM, IMAGE PROCESSING METHOD, AND IMAGE PROCESSING PROGRAM PRODUCT

(71) Applicant: KONICA MINOLTA, INC., Tokyo (JP)

(72) Inventor: Ryuta KONISHI, Tokyo (JP)

(73) Assignee: KONICA MINOLTA, INC., Tokyo (JP)

(21) Appl. No.: 19/467,888

(22) Filed: Feb. 3, 2026

(30) Foreign Application Priority Data
Feb. 10, 2025 (JP) 2025-020090

(51) Int. Cl. G06T 7/00; G06V 10/75; G06V 10/77; G06V 10/774

(52) U.S. Cl. CPC G06T 7/0016; G06V 10/751; G06V 10/759; G06V 10/7715; G06V 10/774; G06T 2207/10116; G06T 2207/20081; G06T 2207/30068; G06T 2207/30096; G06V 2201/03

(57) ABSTRACT

An image processing apparatus including a first medical image input receiver, a second medical image input receiver, and a hardware processor. The first medical image input receiver is configured to receive, as input, first medical image information obtained by imaging a first region of a subject. The second medical image input receiver is configured to receive, as input, second medical image information that is to be paired with the first medical image information. The hardware processor is configured, as a learning part, to learn a difference based on the first medical image information and the second medical image information to construct a learning model.

### CROSS-REFERENCE STATEMENT

The present application is based on, and claims priority from, Japan Application Serial Number 2025-020090, filed Feb. 10, 2025, the disclosure of which is hereby incorporated by reference herein in its entirety.

### BACKGROUND OF THE INVENTION

### Technical Field

The disclosure relates to an image processing apparatus, an image processing system, an image processing method, and an image processing program product. For example, the disclosure may relate to an image diagnostic apparatus for performing image diagnosis using an X-ray radiographic image from mammography.

### Description of Related Art

In X-ray imaging including mammography, a plurality of captured images are compared and contrasted. That is, interpretation of a captured image (for example, a mammogram) is performed by comparing and contrasting a left side and right side of a two sided image. For example, Patent Literature 1 (Japanese Unexamined Patent Publication No. 2021-111076) discloses a diagnostic apparatus that includes a first medical image input part and a second medical image input part (see especially Abstract, paragraphs 0044, 0046, and 0122 of Patent Literature 1). The first medical image input part is for inputting a first medical image that captures a first region of a patient. The second medical image input part is for inputting a second medical image capturing a second region that is a different region from the first region. Note that the invention described in Patent Literature 1 performs fully connected processing.

In the technique described in Patent Literature 1, the first region is the mediastinum and the second region includes a part of the liver. That is, in the technique described in Patent Literature 1, a connection between the first region and the second region is low.

### SUMMARY OF THE INVENTION

An object of the disclosure is to provide an image processing apparatus, an image processing system, an image processing method, and an image processing program product capable of undergoing learning appropriately when a first region and a second region are related to each other.

To achieve at least one of the above-mentioned objects, a first aspect of the disclosure provides an image processing apparatus including a first medical image input receiver, a second medical image input receiver, and a hardware processor. The first medical image input receiver is configured to receive, as input, first medical image information obtained by imaging a first region of a subject. The second medical image input part is configured to receive, as input, second medical image information that is to be paired with the first medical image information. The hardware processor is configured, as a learning part, to learn a difference based on the first medical image information and the second medical image information to construct a learning model.

### BRIEF DESCRIPTION OF THE DRAWINGS

Advantages and features provided by one or more embodiments of the disclosure will become more fully understood from the detailed description given hereinbelow and the appended drawings which are given by way of illustration only, and thus are not intended as a definition of the limits of the disclosure.

FIG. 1 is a configuration diagram of an image diagnostic system according to a first embodiment of the disclosure.

FIG. 2 is a configuration diagram of the image diagnostic system according to the first embodiment of the disclosure at an inference stage.

FIG. 3 is an explanatory diagram for explaining an operation of a controller.

FIG. 4 is an explanatory diagram for explaining operations of an encoder, a decoder, and an asymmetry decoder.

FIG. 5 is an explanatory diagram for explaining a function of a downsizing layer.

FIG. 6 is an explanatory diagram for explaining a function of an upsizing layer.

FIG. 7 is an example of captured images showing a mass shadow.

FIG. 8 is an example of captured images when calcification has occurred.

FIG. 9 is an explanatory diagram for explaining an operation of a controller that is a comparative example of the disclosure.

FIG. 10 is a configuration diagram of an image diagnostic system according to a second embodiment of the disclosure.

### DETAILED DESCRIPTION

In the following description, one or more embodiments of the disclosure will be described in detail with reference to the drawings. However, the scope of the invention is not limited to the disclosed embodiments. Further, it should be noted that the drawings are merely schematic to an extent that the disclosure may be fully understood. Therefore, the disclosure may not be limited to examples illustrated in the drawings. Furthermore, in the respective drawings, common constituent elements or similar constituent elements are denoted by the same reference signs, and duplicate description thereof is omitted.

An image processing apparatus of the disclosure includes a first medical image input part, a second medical image input part, and a learning part. The first medical image input part is configured to receive as input first medical image information obtained by imaging a first region of a subject. The second medical image input part is configured to receive as input second medical image information to be paired with the first medical image information. The learning part is configured to perform learning based on the first medical image information and the second medical image information to construct a learning model.

### First Embodiment

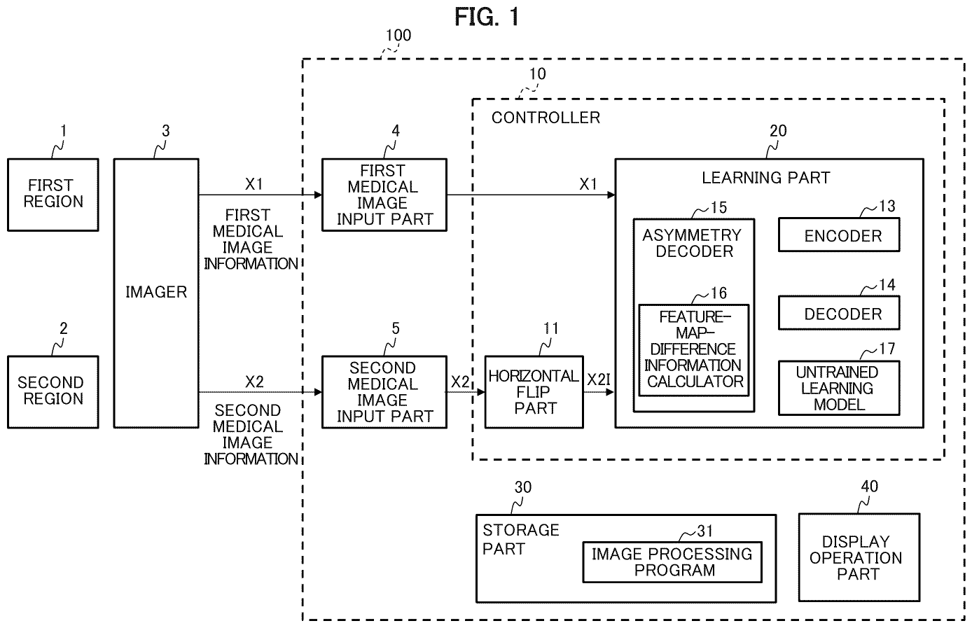

FIG. 1 is a configuration diagram of an image diagnostic system according to a first embodiment of the disclosure.

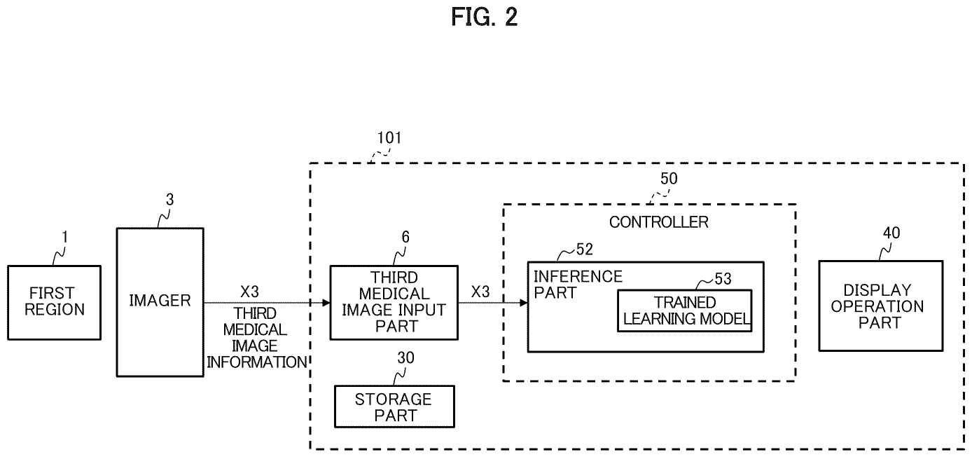

The image diagnostic system S is a mammography image diagnostic system in which an imager 3 and an image processing apparatus 100 (FIG. 1), 101 (FIG. 2) are connected. The image processing apparatus 100 (FIG. 1) is a configuration at a learning stage, and the imager 3 images the first region 1 and a second region 2. The second region 2 to be paired with the first region 1 is, for example, a region bilaterally symmetrical to the first region 1 with respect to a central axis of a body of the subject. The image processing apparatus 101 (FIG. 2) is a configuration at an inference stage (a stage of use), and the imager 3 images only the first region 1. Note that the configurations of the image processing apparatuses 100 and 101 may be combined at the inference stage (stage of use).

The imager 3 illustrated in FIG. 1 is an X-ray imaging apparatus that images a first region 1 and a second region 2 that is bilaterally symmetrical to the first region 1. For example, when the first region 1 is one breast, the second region 2 is the other breast. In other words, the first region 1 and the second region 2 form a pair. For example, the first region 1 and the second region 2 may be kidneys or lungs. The imager 3 outputs the first medical image information X1 when imaging the first region 1, and outputs the second medical image information X2 when imaging the second region 2. The imager 3 may image the first region 1 and the second region 2 on the same examination date or on different examination dates. That is, the second medical image information may be, but is not limited to, past image information obtained by imaging the subject before the imaging date of the first medical image information.

The image processing apparatus 100 includes a first medical image input part 4 (first medical image input receiver), a second medical image input part 5 (second medical image input receiver), a controller 10, a storage part 30 (storage), and a display operation part 40. The first medical image input part 4 is input with first medical image information X1. The second medical image input part 5 is input with second medical image information X2. Here, since the first region 1 and the second region 2 form a pair, the first medical image information X1 and the second medical image information X2 also form a pair.

The controller 10 includes a central processing unit (CPU) and a graphics processing unit (GPU). The controller 10 executes an image processing program 31 to function as a horizontal flip part 11 and the learning part 20. The horizontal flip part 11 is a pre-processing part that flips an image of the second medical image information X2 horizontally to generate a second medical image reverse information X2I.

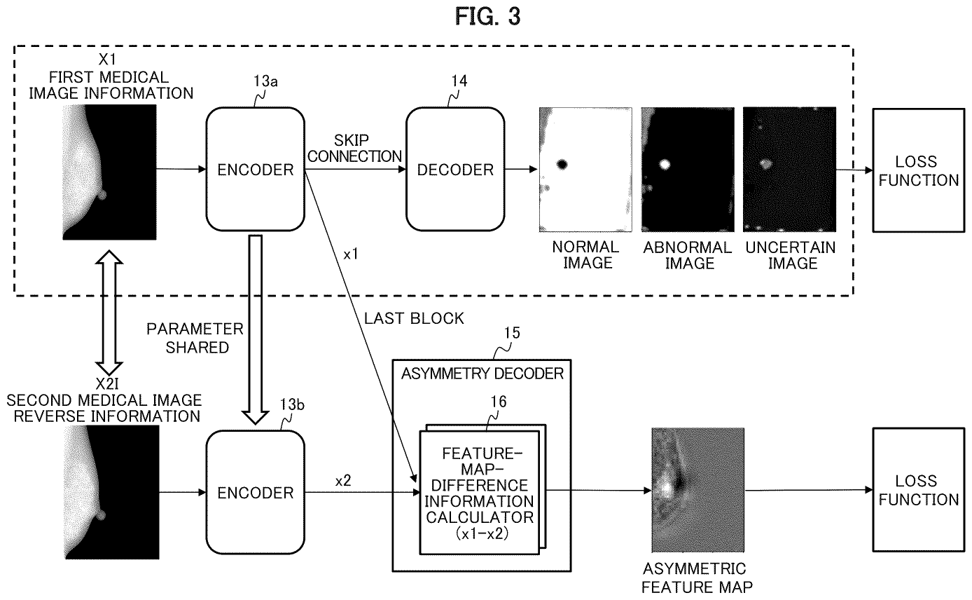

The learning part 20 includes an encoder 13, a decoder 14, an asymmetry decoder 15, and an untrained learning model 17. The encoder 13 convolves the first medical image information X1 and the second medical image reverse information X2I with a predetermined parameter to generate respective feature maps x1 and x2 (FIG. 3). Using the feature map x1 generated by the encoder 13, the decoder 14 generates a diagnostic image with a predetermined parameter. As shown in FIG. 3, the diagnostic image is classified as a normal image, an abnormal image, or an uncertain image. The asymmetry decoder 15 includes a feature-map-difference feature map calculator 16 (described as “feature-map-difference information calculator 16” in FIGS. 1 and 3). The feature-map-difference feature map calculator 16 generates a difference feature map (x1-x2) from the feature map x1 and the feature map x2. The asymmetry decoder 15 generates an image of an asymmetric feature map based on the difference feature map (x1-x2).

The learning part 20 learns with the asymmetry decoder 15, and reflects a loss function of the difference feature map (x1-x2) in a gradient parameter of the encoder 13. As a result, the untrained learning model 17 becomes a trained learning model 53 (FIG. 2). By this learning, the trained learning model 53 becomes a learning model capable of performing inference that takes into consideration a feature that is based on a statistical difference between the first medical image and the second medical image.

The storage part 30 is configured to include a non-volatile storage part, such as read-only memory (ROM) or a hard disk drive (HDD), and a volatile storage part, such as random access memory (RAM). The storage part 30 stores therein an operating system (OS) and an image processing program 31. The display operation part 40 is a liquid crystal display (LCD) panel with a touch function.

FIG. 2 is a configuration diagram of the image diagnostic system S according to the first embodiment of the disclosure at an inference stage.

As in FIG. 1, the imager 3 and the image processing apparatus 101 are connected to each other in the image diagnostic system S. At the inference stage, the imager 3 takes an image of the first region 1 only and does not take an image of the second region 2 (FIG. 1). Similarly to the image processing apparatus 100 (FIG. 1), the image processing apparatus 101 includes a third medical image input part 6 (third medical image input receiver), a controller 50, a storage part 30 (storage), and a display operation part 40. The third medical image input part 6 is input with third medical image information X3 output by the imager 3 when the imager 3 images the first region 1 after an imaging date of the first medical image information.

The controller 50 implements a function as an inference part 52 by executing the image processing program 31 (FIG. 1). Using the trained learning model 53 constructed by the learning part 20 (FIG. 1), the inference part 52 infers a feature that is likely to have a left-right difference. In this way, a mass area may be detected, and an assessment (benign or malignant) thereof may be performed. Note that the inference may include image output, assessment on benignity or malignancy, or the like.

FIG. 3 is an explanatory diagram for explaining operations of the controller 10 (FIG. 1), 50 (FIG. 2).

An inside of a broken line in an upper part of the diagram and a lower part of the diagram illustrate an operation that the controller 10 performs at the learning stage. The inside of the broken line in the upper part indicates an operation that the controller 50 performs at the inference stage. The encoder 13 (FIG. 1) is divided into two encoders 13a and 13b for the sake of description.

At the learning stage, the encoder 13a generates the feature map x1 of the first medical image information X1, and the encoder 13b generates the feature map x2 of the second medical image reverse information X2I. At this time, the encoder 13a is connected to the decoder 14 by a skip connection, but generates the feature map x1 by using only the last block. Further, the two encoders 13a and 13b share a parameter. The feature-map-difference feature map calculator 16 calculates a difference feature map (x1-x2) from the feature map x1, generated by the encoder 13a, and the feature map x2, output by the encoder 13b. The asymmetry decoder 15 generates an image of an asymmetric feature map based on the difference feature map (x1-x2).

The learning part 20 (FIG. 1) calculates a loss function of the asymmetric feature map and a loss function (Loss) of a mass portion. As the loss function (Loss), for example, FocalTverskyLoss is adopted.

$$\begin{matrix}FocalTverskyLoss = \sum ( TverskyLoss ) 1 / Y \\ TverskyLoss = 1 - Tversky\_index \\ Tversky\_index = T P / ( T P + α F N + β F P )\end{matrix}$$

Here, α=0.6 and β=0.2.
TP (True Positive): an area that is correctly determined to be positive.
FP (False Positive): an area that is incorrectly determined to be positive.
FN (False Negative): an area that is incorrectly determined to be negative.

Then, the learning part 20 (FIG. 1) sets a parameter so as to reduce an influence of FP (an area that is incorrectly determined to be positive).

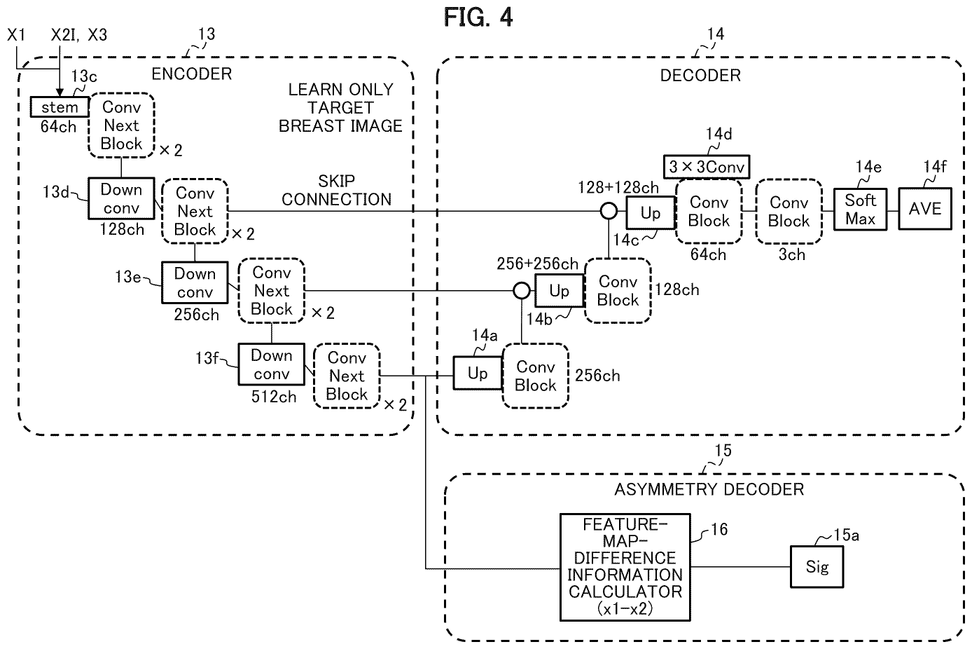

FIG. 4 is an explanatory diagram for explaining operation of the encoder 13, the decoder 14, and the asymmetry decoder 15.

The encoder 13 includes a convolutional layer including a stem layer 13c and three downsizing layers 13d, 13e, and 13f. The stem layer 13c and the downsizing layers 13d, 13e, and 13f are formed of a so-called ConvNextBlock. The first medical image information X1 and the second medical image reverse information X21 are individually input to the stem layer 13c. In the stem layer 13c, which is the first layer, kernel=9 and stride=2 are set. Thus, fine features of a lesion are secured so as not to be excessively reduced. Further, the number of channels becomes 64ch in the stem layer 13c. In the downsizing layers 13d, 13e, and 13f, the number of channels is increased to 128ch, 256ch, and 512ch respectively while down-sampling is performed.

Feature maps are connected between the encoder 13 and the decoder 14 by skip connections. A skip connection is a mechanism by which forward propagation or backward propagation may be performed between separated layers by a detour path that skips a plurality of layers in the middle by N layers and connects to a layer further away. In this way, the encoder 13 forms a wide receptive field by repeating down-sampling and convolution. The decoder 14 performs deconvolution (transposed convolution) while incorporating a feature map on the encoder 13 side by a skip connection. Deconvolution is performing convolution after interpolating input data. As a result, data compressed by the encoder 13 returns to an original size.

The decoder 14 includes three upsizing layers 14a, 14b, and 14c, a 3×3 convolution layer 14d, a softmax function unit 14e, and an averaging processing unit 14f. Each of the upsizing layers 14a, 14b, and 14c and the 3×3 convolution layer 14d is formed of a so-called ConvBlock.

To the three upsizing layers 14a, 14b, and 14c, feature maps generated by the encoder 13 to which the first medical image information X1 is input are input by skip connections. The upsizing layer 14a upsizes the feature map (512ch) of the downsizing layer 13f and reduces the number of channels to 256ch. The upsizing layer 14b outputs a feature map of 128ch by using the feature map (256ch) of the downsizing layer 13e and the feature map (256ch) generated by the upsizing layer 14a. The upsizing layer 14c outputs a feature map of 64ch by using the feature map (128ch) of the downsizing layer 13d and the feature map (128ch) generated by the upsizing layer 14b.

The 3×3 convolution layer 14d upsizes the feature map of 64ch output by the upsizing layer 14c and converts the feature map into 3ch (e.g., R, G, and B).

The softmax function unit 14e performs adjustment so that, when there are n pieces of data, the sum of values thereof becomes 1 (100%). With a softmax function, a value that is greater than or equal to 0 and less than or equal to 1 is output, and the sum of output values is 1 (100%). Therefore, an output value may be used as a probability. When the number of pieces of data is two, the softmax function is a sigmoid function.

The averaging processing unit 14f averages the output values of the softmax function unit 14e.

The asymmetry decoder 15 includes a feature-map-difference feature map calculator 16 and an encoding unit 15a. The feature-map-difference feature map calculator 16 calculates difference information (x1-x2) between a feature map x1 and a feature map x2. The feature map x1 is a feature map of an output layer (downsizing layer 13f) of the encoder 13 when the first medical image information X1 is input to the encoder 13. The feature map x2 is a feature map of the output layer (downsizing layer 13f) when the second medical image reverse information X2I is input to the encoder 13.

The encoding unit 15a obtains an effective code (data representation) that represents a difference (x1-x2) between the feature map x1 and the feature map x2.

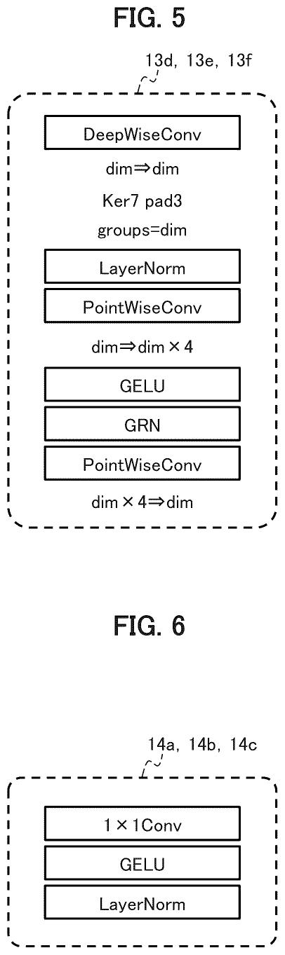

FIG. 5 is an explanatory diagram explaining functions of the downsizing layers 13d, 13e, and 13f. The downsizing layers 13d, 13e, and 13f implement functions of DeepWise Convolution, LayerNormal, a first PointWise Convolution, a Gaussian-Error Linear Unit (GELU), a Global Response Normalization (GRN), and a second PointWise Convolution, or the like. GELU is a Gaussian-error linear unit.

For the DeepWise Convolution, the kernel is set to 7 and the padding is set to 3. The LayerNormal normalizes across all channels for each image. The PointWise Convolution is a 1×1 convolution layer. The convolution layer of 1×1 selects and takes out important parts from an input layer, and combines the parts into one layer. By repeating this processing, a number of layers may be easily set to any value. The GELU is a probabilistic, ReLU-type activation function in a form in which the ReLU is multiplied by a gate coefficient that takes a probability value along an input value. The GRN diversifies patterns of activation by lateral inhibition, and prevents collapse of a feature map that occurs when a masked autoencoder (MAE) is applied to a convolutional neural network (CNN). The MAE is a technique in which, before an image is input to an encoder, a portion of the image, which is divided into patches, is masked. By this technique, an output of the encoder is added with a placeholder corresponding to a masked patch portion and input to a decoder to reconstruct the original image.

FIG. 6 is an explanatory diagram for explaining functions of the upsizing layers 14a, 14b, and 14c.

The upsizing layers 14a, 14b, and 14c implement functions of a 1×1 convolution layer, the GELU, and the LayerNormal, or the like. These functions are described with FIG. 5.

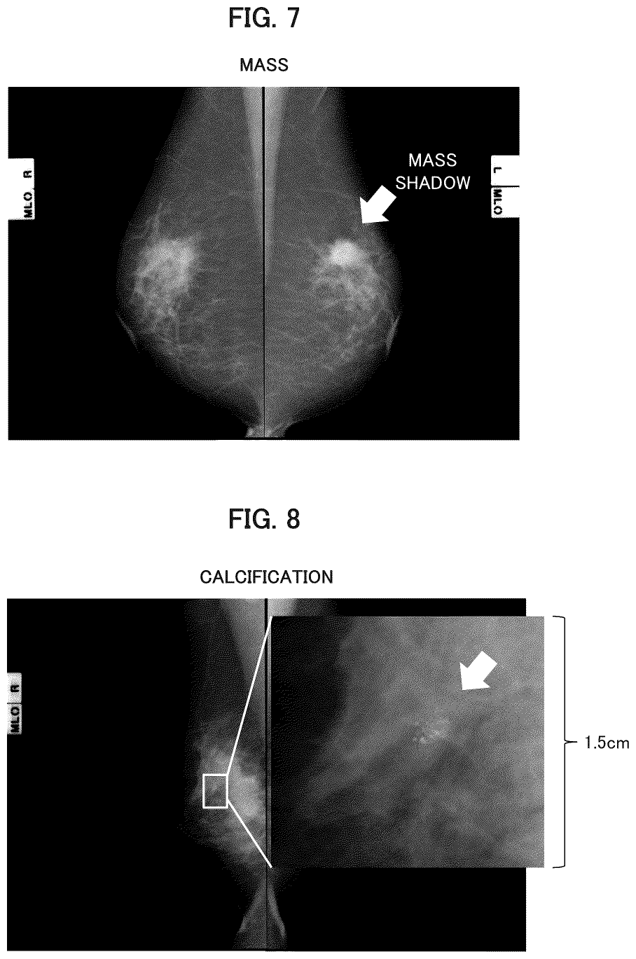

FIG. 7 is an example of captured images showing a mass shadow.

The two images are mammograms of the left and right breasts taken from a side. The two images are bilaterally symmetric, but there is a mass shadow in the left breast. Note that a shadow creating a difference between the left and right images may be a focal asymmetric density (FAD) or a distortion of a structure rather than a mass shadow.

FIG. 8 is an example of captured images when calcification has occurred.

The term “calcification” refers to a state in which calcium is deposited in a mammary gland. In an enlarged photograph of a part (vertical 1.5 cm) of the right breast, there are bright spots whose sizes are 0.5 mm to 1 mm, and these bright spots indicate calcifications.

### Comparative Example

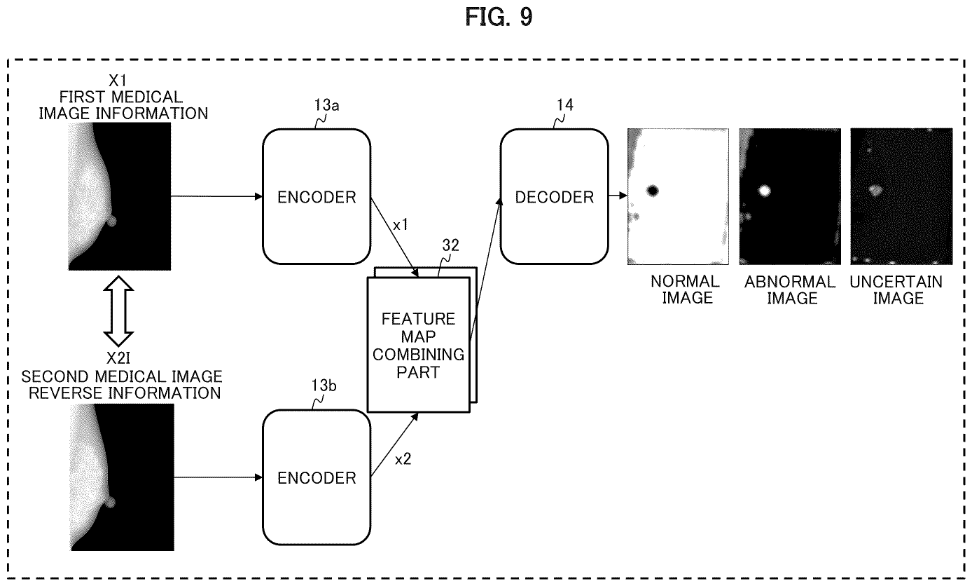

FIG. 9 is an explanatory diagram illustrating an operation of a controller that is a comparative example of the disclosure.

An encoder 13a generates a feature map x1 of the first medical image information X1, and an encoder 13b generates a feature map x2 of the second medical image reverse information X2I. A feature map combining part 32 combines the feature map x1 and the feature map x2 (full connection). Using the combined feature map that is output by the feature map combining part 32, the decoder 14 generates a diagnostic image with a predetermined parameter. The diagnostic image is classified as a normal image, an abnormal image, or an uncertain images.

That is, a configuration of the present comparative example is different from that of the above-described embodiment in that the configuration includes the feature map combining part 32 instead of the feature-map-difference feature map calculator 16 (FIGS. 1, 3).

### Second Embodiment

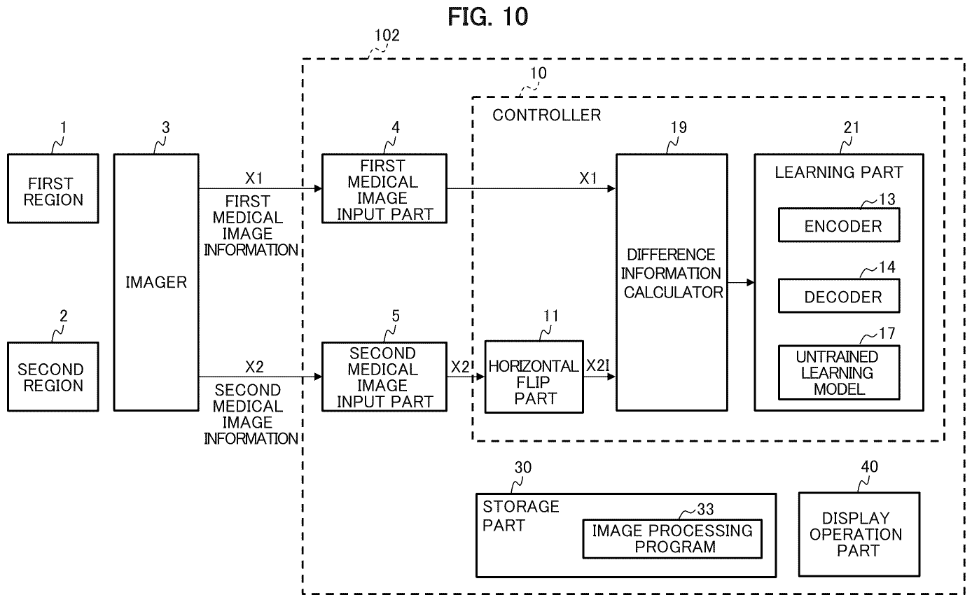

In the first embodiment, the feature-map-difference feature map calculator 16 is provided in the learning part 20 (FIG. 1). However, a difference feature map calculator 19 (FIG. 10) may be provided outside the learning part 21 (FIG. 10).

FIG. 10 is a configuration diagram of an image diagnostic system according to a second embodiment of the disclosure.

The image processing apparatus 102 includes a first medical image input part 4 (first medical image input receiver), a second medical image input part 5 (second medical image input receiver), a controller 10, a storage part 30 (storage), and a display operation part 40. The controller 10 implements functions as a horizontal flip part 11, a difference feature map calculator 19 (described in FIG. 10 as “difference information calculator 19”), and a learning part 21 by executing an image processing program 33. The horizontal flip part 11 is a pre-processing part that flips an image of the second medical image information X2 horizontally to generate reverse image information (second medical image reverse information X2I).

The difference feature map calculator 19 generates a difference image between an output image of the first medical image input part 4 and an output image of the horizontal flip part 11. The learning part 20 includes an encoder 13, a decoder 14, and an untrained learning model 17. The encoder 13 convolves an output image of the difference feature map calculator 19 to generate a respective feature map. Using the feature map x1 generated by the encoder 13, the decoder 14 generates a diagnostic image with a predetermined parameter.

### Modification Example

The disclosure is not limited to the above-described embodiments and may be embodied in a modified form without departing from the spirit and scope of the disclosure. For example, modifications include the following (a) to (b).
(a) In each of the above-described embodiments, the first region 1 (FIGS. 1 and 10) and the second region 2 (FIGS. 1 and 10) are breasts, and the captured images are substantially bilaterally symmetrical. Due to this, the controller 10 performs pre-processing with the horizontal flip part 11 (FIGS. 1 and 10). However, the first region 1 and the second region 2 may be considered to be similar regions, and pre-processing by a horizontal flip may not be performed. That is, if the first medical image information X1 and the second medical image information X2 are similar images that are similar to each other, the learning part 20 may perform learning based on a difference feature map obtained by calculating a difference between the feature map of the first medical image information X1 and a feature map of the second medical image information X2. For example, similar regions that form a left and right pair, such as arms, feet, lungs, or kidneys, may be applicable as the first region 1 and the second region 2.
(b) In each of the above-described embodiments, the imager 3 images both the first region 1 and the second region 2 that are substantially bilaterally symmetrical, and the learning part 20 (FIG. 1) learns with the captured images. In one or more embodiments, the learning part 20 may perform learning by using a past image of the first region 1 instead of the second region 2. That is, the inference part 52 (FIG. 2) may perform learning by being inputted with second medical image information that is obtained by imaging the first region 1 at a different timing. In this case, it may be possible to reflect, in the learning, a feature that takes into account a difference over time. A plurality of past images of the first region 1 are used in the learning, and either of the past images is the first medical image information, and the other past image is the second medical image information to be paired with the first medical image information.

### Aspects

A first aspect of the disclosure provides an image processing apparatus including a first medical image input part, a second medical image input part, and a learning part. The first medical image input part is configured to receive, as input, first medical image information obtained by imaging a first region of a subject. The second medical image input part is configured to receive, as input, second medical image information that is to be paired with the first medical image information. The learning part is configured to learn a difference based on the first medical image information and the second medical image information to construct a learning model.

A second aspect of the disclosure provides the image processing apparatus according to the first aspect, further including an inference part. The inference part is configured to perform an inference by inputting, to the learning model, third medical image information that has been obtained by imaging the first region after an imaging date of the first medical image information.

A third aspect of the disclosure provides the image processing apparatus according to the first aspect, further including a horizontal flip part. A second region to be paired with the first region is a region that is bilaterally symmetrical to the first region. The horizontal flip part is configured to generate reverse image information obtained by horizontally flipping an image of the second medical image information. The learning part is configured to learn based on a difference feature map obtained by calculating a difference between a feature map of the first medical image information and a feature map of the reverse image information.

A fourth aspect of the disclosure provides the image processing apparatus according to the first aspect, and in which the first medical image information and the second medical image information are similar images that are similar to each other. The learning part is configured to learn based on a difference feature map obtained by calculating a difference between a feature map of the first medical image information and a feature map of the second medical image information.

A fifth aspect of the disclosure provides an image processing apparatus according to any one of the first, second, third, and fourth aspects, in which the second medical image information is past image information obtained by imaging the subject before an imaging date of the first medical image information.

A sixth aspect of the disclosure provides an image processing apparatus including an inference part. The inference part is configured to learn based on first medical image information obtained by imaging a first region of a subject and second medical image information to be paired with the first medical image information. Further, the inference part is configured to perform inference by inputting third medical image information to a learning model constructed from the learning. The third medical image information is obtained by imaging the first region after an imaging date of the first medical image information.

A seventh aspect of the disclosure provides an image processing apparatus including a first medical image input part, a second medical image input part, a learning part, and an inference part. The first medical image input part is configured to receive, as input, first medical image information obtained by imaging a first region of a subject. The second medical image input part is configured to receive, as input, second medical image information that is to be paired with the first medical image information. The learning part is configured to learn based on the first medical image information and the second medical image information to construct a learning model. The inference part is configured to perform inference by inputting, to the learning model, third medical image information obtained by imaging the first region after an imaging date of the first medical image information.

An eighth aspect of the disclosure provides the image processing apparatus according to the seventh aspect, in which the second medical image information is information obtained by imaging the first region on a date different to an imaging date of the first medical image information.

A ninth aspect of the disclosure provides an image processing method of an image processing apparatus, in which the image processing apparatus includes a first medical image input part and a second medical image input part. The first medical image input part is configured to receive, as input, first medical image information obtained by imaging a first region of a subject. The second medical image input part is configured to receive, as input, second medical image information that is to be paired with the first medical image information. The image processing method is executed by a controller of the image processing apparatus. The image processing method includes learning based on the first medical image information and the second medical image information to construct a learning model.

A tenth aspect of the disclosure provides a non-transitory computer readable storage medium storing an image processing program executable by a computer of an image processing apparatus, in which the image processing apparatus includes a first medical image input part and a second medical image input part. The first medical image input part is configured to receive, as input, first medical image information obtained by imaging a first region of a subject. The second medical image input part is configured to receive, as input, second medical image information that is to be paired with the first medical image information. The image processing program causes the computer to learn based on the first medical image information and the second medical image information to construct a learning model.

### Advantageous Effects

According to the disclosure, it is possible to appropriately learn when the first region and the second region are related to each other.

Although embodiments of the disclosure have been described and illustrated in detail, the disclosed embodiments are made for purposes of illustration and example only and not limitation. The scope of the disclosure should be interpreted by terms of the appended claims.

What is claimed is:

1. An image processing apparatus comprising:
a first medical image input receiver configured to receive, as input, first medical image information obtained by imaging a first region of a subject;
a second medical image input receiver configured to receive, as input, second medical image information that is to be paired with the first medical image information; and
a hardware processor configured, as a learning part, to learn a difference based on the first medical image information and the second medical image information to construct a learning model.

2. The image processing apparatus according to claim 1, wherein
the hardware processor is configured, as an inference part, to perform an inference by inputting, to the learning model, third medical image information that has been obtained by imaging the first region after an imaging date of the first medical image information.

3. The image processing apparatus according to claim 1, wherein
a second region to be paired with the first region is a region that is bilaterally symmetrical to the first region,
the hardware processor is configured, as a horizontal flip part, to generate reverse image information obtained by horizontally flipping an image of the second medical image information, and
the hardware processor is configured, as the learning part, to learn based on a difference feature map obtained by calculating a difference between a feature map of the first medical image information and a feature map of the reverse image information.

4. The image processing apparatus according to claim 1, wherein
the first medical image information and the second medical image information are similar images that are similar to each other, and
the hardware processor is configured, as the learning part, to learn based on a difference feature map obtained by calculating a difference between a feature map of the first medical image information and a feature map of the second medical image information.

5. The image processing apparatus according to claim 1, wherein
the second medical image information is past image information obtained by imaging the subject before an imaging date of the first medical image information.

6. An image processing apparatus, comprising a hardware processor configured, as an inference part, to:
learn based on first medical image information obtained by imaging a first region of a subject and second medical image information to be paired with the first medical image information; and
perform inference by inputting third medical image information to a learning model constructed from the learning, wherein the third medical image information is obtained by imaging the first region after an imaging date of the first medical image information.

7. An image processing apparatus, comprising:
a first medical image input receiver configured to receive, as input, first medical image information obtained by imaging a first region of a subject;
a second medical image input receiver configured to receive, as input, second medical image information that is to be paired with the first medical image information; and
a hardware processor, wherein
the hardware processor is configured, as a learning part, to learn based on the first medical image information and the second medical image information to construct a learning model, and
the hardware processor is configured, as an inference part, to perform inference by inputting, to the learning model, third medical image information obtained by imaging the first region after an imaging date of the first medical image information.

8. The image processing apparatus according to claim 7, wherein
the second medical image information is information obtained by imaging the first region on a date different to an imaging date of the first medical image information.
